(19) United States
(12) Patent Application Publication
(10) Pub. No.: US 2020/0279322 A1
(43) Pub. Date: Sep. 3, 2020

(54) Dynamic Credit Allocating System

(71) Applicant: Divvy Pay Inc., Lehi, UT (US)

(72) Inventors: Blake Murray, Sandy, UT (US); Greg Larson, Lehi, UT (US)

(73) Assignee: Divvy Pay Inc., Lehi, UT (US)

(21) Appl. No.: 16/163,135

(22) Filed: Oct. 17, 2018

(51) Int. Cl. G06Q 40/02; G06Q 20/40; G06Q 10/10; G06Q 40/00; G06F 16/23

(52) U.S. Cl. CPC G06Q 40/025; G06Q 20/4037; G06F 16/2379; G06Q 40/12; G06Q 10/105

(57) ABSTRACT

Systems and methods for dynamically allocating credit to a consumer or organization are disclosed. Transaction data for the consumer are stored and analyzed to determine whether or not to increase or decrease credit for the consumer. The systems and methods include analyzing past transaction data to determine whether or not a similar circumstance has faced the consumer in the past, whether or not the credit at that time was sufficient, and whether or not to change the present credit to the consumer in response.

### BACKGROUND

Many companies' current methods of tracking expenses is cumbersome and outdated. Most companies use standard-issue credit cards which are handed out to employees with verbal instructions on how or what to spend. Most companies do not control employee spending except for monitoring expenses after they have been incurred—when it is too late to do anything about any problems. Many employees have zero ability to spend money on behalf of the company because the process of monitoring and tracking expenses, and the trust required to execute properly, are not in place. Another method of tracking expenses is by requiring employees to keep physical receipts, turn them in, and wait for a reimbursement. Another inefficiency of current company spending is loyalty rewards which card issuers provide are benefits which flow to the employee, not the company paying the bill. A new way to track expenses and monitor employee activity is required.

Credit given to customers such as individual consumers and organizations is based on a variety of factors such as the customer's trustworthiness, past history of credit use, and spending habits. Credit limits on instruments such as credit cards can be adjusted but is typically a slow process that is based on factors that may or may not accurately represent the risk associated with such a change. Credit is a valuable tool that can be used to access capital at critical times for a business and can make the difference between being able to capitalize on an opportunity and missing out. Such decisions are not typically made quickly enough to keep pace with today's business environment, and are not typically made using the best available data, resulting in lost opportunities. There is a need in the art for a system that can adjust credit to accommodate today's high-speed markets and that can make appropriate decisions based on the best available data.

### SUMMARY

Embodiments of the present disclosure are directed to a system for dynamically allocating credit to a credit holder. The system includes a monitoring module configured to monitor transactions executed by the credit holder using a payment instrument, including parameters pertaining to the transactions, the monitoring module being configured to perform calculations, and a database configured to store the parameters including past values of the parameters. The monitoring module is configured to communicate with a bank, the bank being the issuer of the instrument. The monitoring module is also configured to, in response to a function call to the monitoring module, identify a first set of the parameters and to compare the first set of parameters to one or more second sets of the parameters, and to identify a similar set of parameters from among the second sets of the parameters, the similar set of parameters being more similar to the current set of parameters than other past parameters. The monitoring module is also configured to establish a degree of similarity between the similar set of parameters and the first set of parameters, and to identify a credit status for the credit holder at the time of the similar set of parameters. The monitoring module may also assess the insufficiency of the credit status, and dynamically allocate credit to the credit holder in concert with the bank according to the insufficiency of the credit status and the degree of similarity.

Further embodiments of the present disclosure are directed to a method for dynamically allocating credit to a customer. The method includes storing transaction data for the customer, receiving a request to analyze a current credit for the customer to determine how to dynamically allocate credit to the customer, and identifying a present set of data from among the transaction data pertaining to the customer at a time the request was received. The method also includes comparing the present set of data to one or more past sets of data from among the transaction data for the customer, and identifying from among the past sets of data a second set of data that is most similar to the present set of data and establishing a degree of similarity between the second set of data and the present set of data. The method then analyzes for adequacy a second credit available to the customer at a time of the second set of data, and compares a present credit available to the customer to the second credit. The method also includes allocating credit to the customer according to the adequacy of the second credit and the degree of similarity between the second set of data and the present set of data.

Still further embodiments of the present disclosure are directed to a method for dynamically allocating credit to a consumer on a transaction-by-transaction basis. The method includes operating a computational model configured to communicate with a bank that issues a financial instrument for the consumer and to monitor for transactions executed by the consumer using the financial instrument and to store data for the transactions, and aggregating the data into parameter sets for each transaction. The method also includes at the time of a proposed transaction aggregating data for the proposed transaction into a first parameter set for the proposed transaction and analyzing whether or not the proposed transaction would exceed a predetermined credit limit for the consumer, and if the proposed transaction would exceed the predetermined credit limit for the consumer, before denying the proposed transaction, analyzing the data to determine a second parameter set that is similar to the first parameter set. The method also includes analyzing whether or not the proposed transaction would have exceeded the credit of the consumer at the time of the second parameter set, and if the proposed transaction would not have exceeded the credit of the consumer at the time of the second parameter set, approving the transaction.

### BRIEF DESCRIPTION OF THE FIGURES

FIG. 1 is a schematic representation of a system for dynamically allocating credit according to embodiments of the present disclosure.

FIG. 2 is a graph of credit against time according to embodiments of the present disclosure.

FIG. 3 is a chart of parameters taken at various times used to dynamically adjust a credit limit for a customer according to embodiments of the present disclosure.

FIG. 4 is a flow chart diagram illustrating methods according to the present disclosure.

FIG. 5 is a flow chart diagram for a method according to embodiments of the present disclosure in which credit is allocated on a transaction-by-transaction basis.

FIG. 6 is an illustrative computer architecture for a computer 290 utilized in the various embodiments will be described.

### DETAILED DESCRIPTION

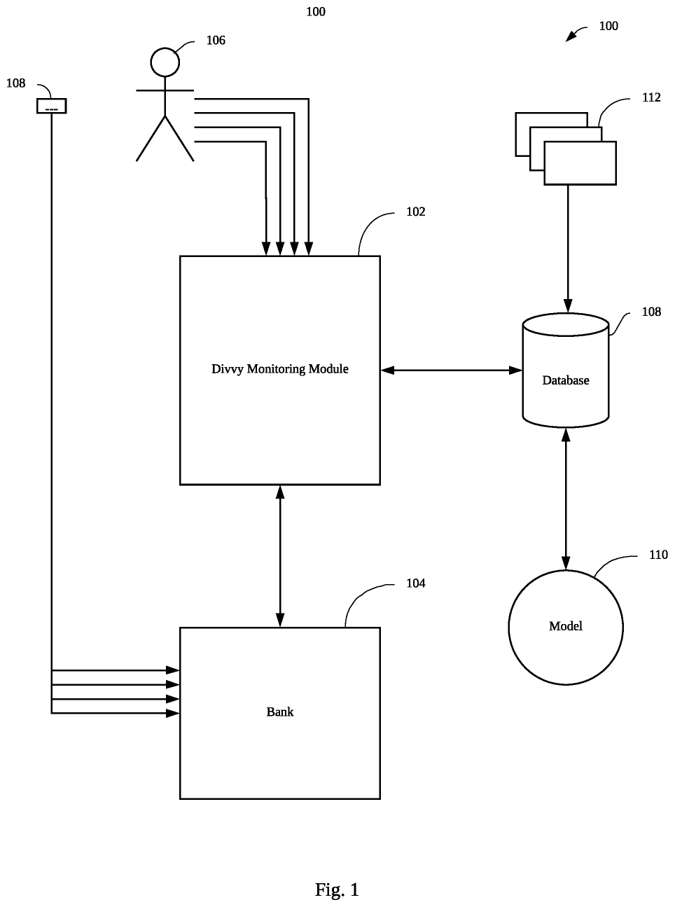

Below is a detailed description according to various embodiments of the present disclosure. FIG. 1 is a schematic representation of a system 100 for dynamically allocating credit according to embodiments of the present disclosure. The system 100 includes a monitoring module 102 that is configured to execute various functions and to communicate information with other components of the system 100 as will be described in detail herein. The monitoring module can comprise a computing unit including a CPU, memory, and communications equipment such as internet communications capabilities. The monitoring module 102 can include a plurality of various physical locations and installations such as server banks, databases, etc. and it can also comprise a collection of algorithms, software, and other instructions that can reside on a server and can be executed by a CPU. It is to be understood by a person of ordinary skill in the art that the monitoring module 102 can take a variety of forms, both physical and intangible.

The monitoring module 102 is configured to communicate with a bank 104. In some embodiments the bank 104 is part of the system 100, while in other embodiments the monitoring module 102 is configured to communicate with a bank that is not under the control of the monitoring module 102 or the entity that controls the monitoring module 102. The bank 104 can issue credit to a consumer 106. For ease of explanation and without loss of generality the consumer 106 is shown and described as a single individual; however, it is to be understood that the consumer 106 can comprise a group of people, an organization, a group of organizations, or any combination thereof. The consumer 106 can make purchases or other transactions using a credit card 108 or a similar instrument as is well known in the art. The bank 104 maintains a line of credit for the consumer and transactions made using the card are paid for by the bank using the line of credit, and then the consumer pays the bank 104. There can be any number of transactions and information for each is stored by the bank 104. The monitoring module 102 is in communication with the bank 104 and is configured to receive the information regarding the transactions. In some embodiments the monitoring module 102 (or an entity controlling the monitoring module) has a relationship with the consumer 106 that establishes an understanding that the transaction information can be shared with the monitoring module 102. In some embodiments the bank 104 and the monitoring module 102 are operated by a single entity, or the monitoring module and its functions are carried out by the bank 104.

Periodically the monitoring module 102 compiles information from transactions into a database 108. The transaction data can be extracted using an ETL (extract, transform, load) process or another equivalent process to compile transaction data into the database 108. The database 108 can be a data warehouse, a data lake, or another suitable repository. For brevity, this and other data repositories are referred to herein as databases. The transaction information can include virtually any measurable data pertaining to the transaction, including amount, time, place, type (debit, credit, etc.), goods/services purchased, etc. The database 108 can also receive information from other accounts 112 belonging to the consumer, such as bank accounts, other credit card accounts, loans, etc. Access to this information is obtained with permission from the consumer and without compromising the security and confidentiality of this information.

In some embodiments the information from other accounts 112 comprises compiled data pertaining to users other than the present consumer 106. The data can be received with permission and can be anonymous and normalized to enable ease of comparison and evaluation. The data 112 can include industry information, stock market information, commodity price information, and any other financial index that may be useful for the purposes of the present disclosure. In some embodiments the data 112 is taken from a group of users having a certain characteristic such as belonging to a company. For example, the consumer 106 may be an individual who works for Company X. Other employees of Company X are also subscribed to the services provided by the monitoring module. The spending activities and other financial information that is obtained by all employees of Company X can be used to provide insight into the circumstances facing Company X. Other delineations are also possible. For example, a group of consumers who hold the same credit card with the same benefits can be used as the other data 112.

The database 108 can perform certain calculations on the transaction data. A model 110 is shown to represent these calculations. There are many mathematical calculations that can be performed on the data, such as regressions, analytics, and many others. The model 110 is used in some embodiments to calculate a number that pertains to the creditworthiness of the consumer based on the transaction data. For example, one result of a calculation can be a number between 0 and 1 representing a spectrum of creditworthiness where 0 represents high risk or low credit worthiness and 1 represents low risk and high creditworthiness. In a specific, non-limiting example the score from the model can return a number of 0.89. This number is closer to 1 than to 0 and this will tend to suggest that the consumer's credit can increase. A different number, such as 0.12 would suggest the opposite—that the risk of further credit is high and that any such increase should not be given.

The results of the model's calculations can then be returned to the monitoring module 102, which in turn reports back to the bank 104. The bank 104 can then make an informed decision regarding the credit extended to the consumer. Accordingly, the credit extended to the consumer 106 is based on an analytical calculation based on a multitude of data about the consumer's past spending and habits. The score can therefore be called a credit adjustment coefficient.

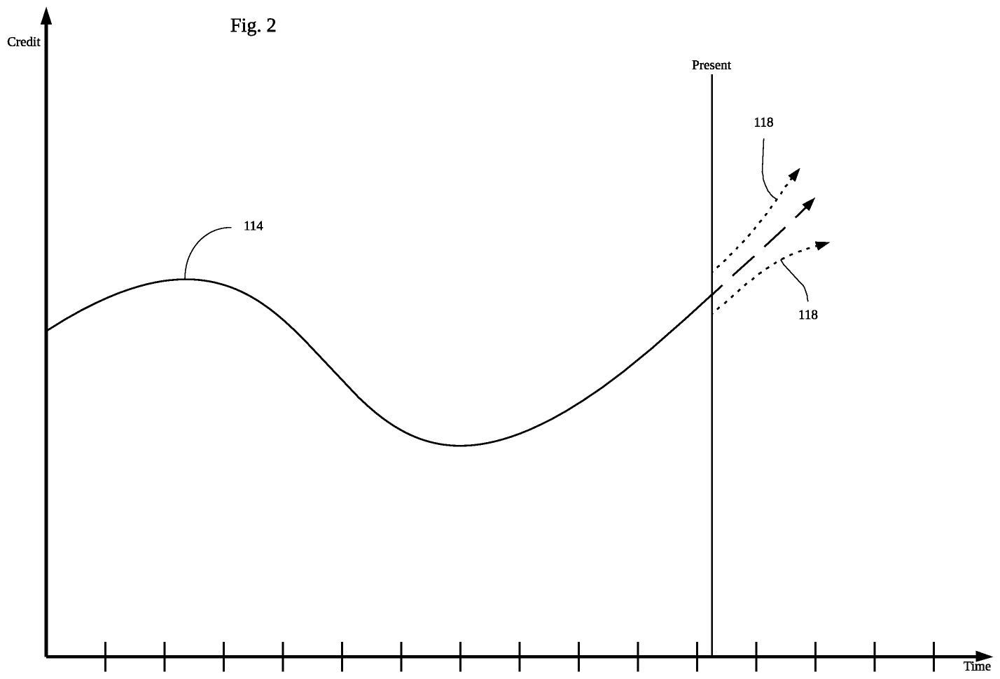

FIG. 2 is a graph of credit against time according to embodiments of the present disclosure. The score can be given as a function of time, such as months. In other embodiments the time interval can be as frequent as desired, limited only by the time required to make the appropriate calculations. For the example shown, the model uses previous uses of the accounts by the consumer to plot out the needs of the consumer in the past as shown by line 114. The line 114 reaches the present moment at which point the score is calculated as described above with reference to FIG. 1. The dashed line 116 represents the expected credit needs of the consumer for the next month or months. The model can calculate a score as a function of time that is based on the activities of the consumer. The shape of the lines 114 and 116 shows a sinusoidal pattern for purposes of explanation. Many businesses are cyclical, such as an agricultural business that is based largely upon the seasons and the weather. The system of the present disclosure can accurately know what the needs of the consumer will be in the upcoming months and can dynamically adjust the credit to accommodate the needs.

In other embodiments the domain of the score is not necessarily time, but can be another parameter including any meaningful, measurable indicia that may affect the business environment and therefore credit needs of the consumer. Activities such as hiring new employees, making capital expenditures, acquiring new properties and/or businesses can each be used in the model to calculate the credit needs of the consumer. The score can be calculated and reported to the bank and the credit can be adjusted upward or downward accordingly. Industry-wide phenomena can also be used as the indicia. For example, if a certain industry is subject to a positive or negative pressure that can be used to calculate the score and adjust the credit. One example of such an indicia is an industry such as the oil and gas industry which is from time to time subject to geopolitical pressures such as wars or changes in policy that affect all oil and gas companies equally. Such information can be delivered to the monitoring module and included in the model to help compute the score for the consumer.

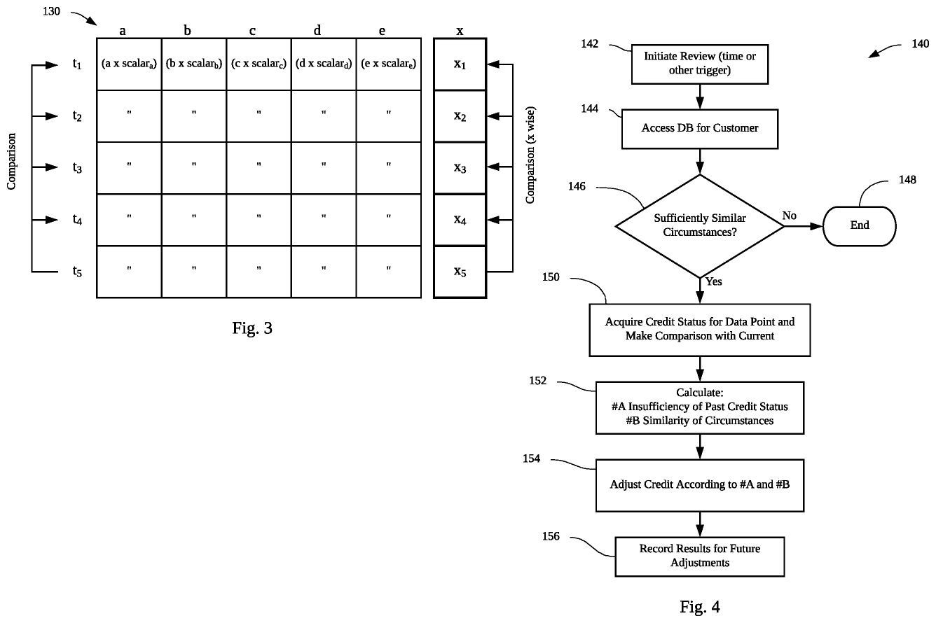

FIG. 3 is a chart 130 of parameters taken at various times used to dynamically adjust a credit limit for a customer according to embodiments of the present disclosure. The columns of the chart 130 are a-e where each pertains to a certain parameter that has bearing on the creditworthiness of an individual. There are myriad possibilities for these parameters, such as outstanding debt, income, assets, and credit score to name a few. There can be any number of parameters for a given customer and the scope of the present disclosure is not limited to using five or any other particular number of parameters. A-e are shown here for purposes of explanation and not in a limiting manner. Similarly, the columns are taken at different times: t₁-t₅. The values for the given parameters a-e can be taken at a single moment in time or can be compiled at different times. Similar to the number of parameters, there can be any number of rows pertaining to any number of entries. The data in each cell may or may not be present for a given entry if some data is unavailable or deemed misleading or false for some reason. Rows 2-5 can also include the value of (a x scalarₙ) wherein n is the row number.

The column at the far left, x, is a sum of the parameters a-e. The sum may be a simple addition or it can be a more sophisticated combination. The numbers may be normalized before combining into x. For example, one parameter may be “Debt” which has units of dollars and cents, and another parameter may be “time since last payment” which has units of time. In order to meaningfully combine these two into x, the data can be normalized. Each parameter can be given a score according to a judgment made about the creditworthiness of the score. For example, the higher the debt may be considered a factor that suggests creditworthiness is low, and a high “time since last payment” may also be so considered. The score for each can be any arbitrary number such as a score between 1-100. Therefore a-e can be added together, or averaged to provide a meaningful overall value for x. In some cases the parameter may have an inverse relationship to creditworthiness, such as a parameter of “number of credit cards” in which a low number suggests a high credit worthiness. The normalization will resolve this into a meaningful value for x.

Some or all of the values in the cells can be multiplied by a scalar value such as shown in FIG. 3 as scalarₐ-scalarₑ. The scalar can be used to normalize the values. It can also be used to weight the values if some of the parameters are more important for a given analysis than others. The use of the scalars will use the judgement of an operator of the systems and methods of the present disclosure.

According to embodiments of the present disclosure, a comparison can be made between a current time or entry, such as t₅ and other entries in the chart. The comparison can be parameter-by-parameter, or it can be done by comparing the x values (x-wise comparison). The comparison can be useful to identify that the customer has been in a situation like the present one before. Using this information the systems and methods enable a dynamic way to alter the credit of the customer based on past experiences. Consider for example a farm that experiences a seasonal up-and-down cycle. The parameters may be something as simple as the calendar or the weather. The systems and methods enable identifying that during warmer months there is a greater need for capital due to expenses incurred to harvest crops, while in the winter there is less such need. The systems and methods enable this identification for any business, using a larger number of parameters. As the number of variables grows, the results are less intuitive and without this data-driven approach there are insights that may be missed.

The comparison can be performed by finding the difference between current values and each (or a subset) of previous entries, and analyzing the difference against a threshold. If the difference is sufficiently small, it means that the business climate currently is similar to what it was at time “N” where time “N” is the time at which the difference between current parameter values is least. The system can continue by looking at what the credit available at that time was, and further can assess whether or not the credit available was sufficient for the needs of the business. If so, it is likely that the credit can advantageously be changed to match what it was at time “N.”

The systems and methods of the present disclosure can also be used to determine if fraud or theft has taken place by making a comparison between current values of the parameters to past values. If a user suddenly spends much more than he or she has done in the past and on different things in different places, the comparison will flag this occurrence and the systems can be used to flag a possible identity theft, fraud, or other improper behavior investigation.

FIG. 4 is a flow chart diagram 140 illustrating methods according to the present disclosure. The method can begin with a triggering event at 142 such as an elapsed time, or a detected change in a monitored parameter, or a manually requested trigger. At 144 a database is accessed to obtain information about a customer. The method shown and described here refers to a single customer, but the methods and systems disclosed herein can also be implemented in batches and can be run as many times as needed for any reasonable number of customers.

At 146 a check is performed to ascertain whether or not the current circumstances facing the customer, as stored in an array of parameters as shown in FIG. 3, are similar to any other, prior situation the customer has faced. This check can be performed by finding a difference between each parameter and a plurality of earlier, stored arrays. In some embodiments the check is performed on a parameter-by-parameter basis, while in other embodiments the sum of the parameters (X in FIG. 3) can be used. The similarity between circumstances can be arbitrarily chosen by setting a threshold parameter. If the differences are greater than this parameter, a “no” is achieved and if less than this parameter, a “yes” is achieved. At 148 if there are no circumstances from an earlier data point then the method can conclude that there is no meaningful insight to apply and the method can end. If, however, there are a set of sufficiently similar circumstances stored somewhere in the database, at 150 the method continues by acquiring a credit status for the data point which was found to be most similar, and by making a comparison between that data point and the current data point.

At 152 the method continues by identifying two numbers: #A, an insufficiency of the credit status held by the customer at the prior data point, and #B, a degree of similarity of the circumstances between the current status and the data point found to be most similar. These two numbers can be combined to identify how much change needs to be made to the customer's credit to accommodate for the current events, considering the past events. Regarding the #A, a high insufficiency of past credit status suggests that past credit was not sufficient, while a low insufficiency (meaning a high sufficiency) suggests that the past credit was adequate. Regarding #B, a high similarity of the circumstances suggests that the current needs of the customer will also be similar to that time. So a high value of B suggests that the confidence the method has in the sufficiency (A) is high. The higher the product of #A and #B is, the more the credit rating will be adjusted.

At 156 the results of the method's implementation are recorded and used for future calculations. This method can be repeated as often as necessary, limited only by the calculating power of the calculator performing the calculation. In some embodiments the method can result in a change in credit status as often as once per day.

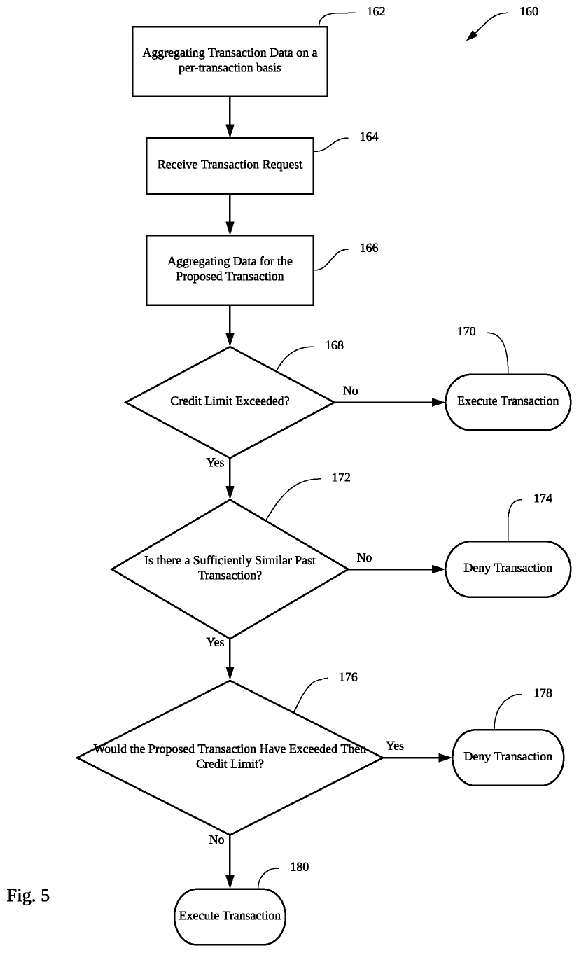

FIG. 5 is a flow chart diagram 160 for a method according to embodiments of the present disclosure in which credit is allocated on a transaction-by-transaction basis. At 162 the method includes aggregating transaction data on a per-transaction basis. The data aggregated can be the same transaction data elsewhere described, including but not limited to amount, time, place, merchant, etc. The transaction data can be stored each time a transaction is executed and time-stamped to allow future review of each transaction and the circumstances surrounding the transaction. At 164 a transaction is proposed such as by swiping a credit card at a point of sale, an online order, or any other method by which transactions are initiated in today's digital marketplace. At 166 the data for the transaction is aggregated into a parameter set for the proposed transaction.

At 168 a check for available credit is initiated. If the limit is not exceeded, at 170 the method executes the transaction. If the credit limit is exceeded, at 172 another check is performed to determine whether or not there is a sufficiently similar past transaction and accompanying data set. The similarity can be arbitrarily set by entering a threshold of similarity between variables in the parameter set. Different variables within the parameter set may have a different standard for similarity, and the judgement of an operator can enter in to this choice. If there is no sufficiently similar past transaction and accompanying data set, the transaction is denied at 174.

If, however, there is a sufficiently similar past transaction and accompanying parameter set, at 176 yet another check is performed, this time to determine whether or not the past transaction would have exceeded the credit available to the customer at the time of the past transaction. If the answer is yes, the transaction is denied at 178. But if the answer is no, then the transaction is allowed at 180.

The method shown in the chart 160 is not limited to a transaction-by-transaction basis. In some embodiments the period of the check is not a transaction, but a time period such as a day, a week, a month, etc. In other embodiments the data can be aggregated in response to a manual request.

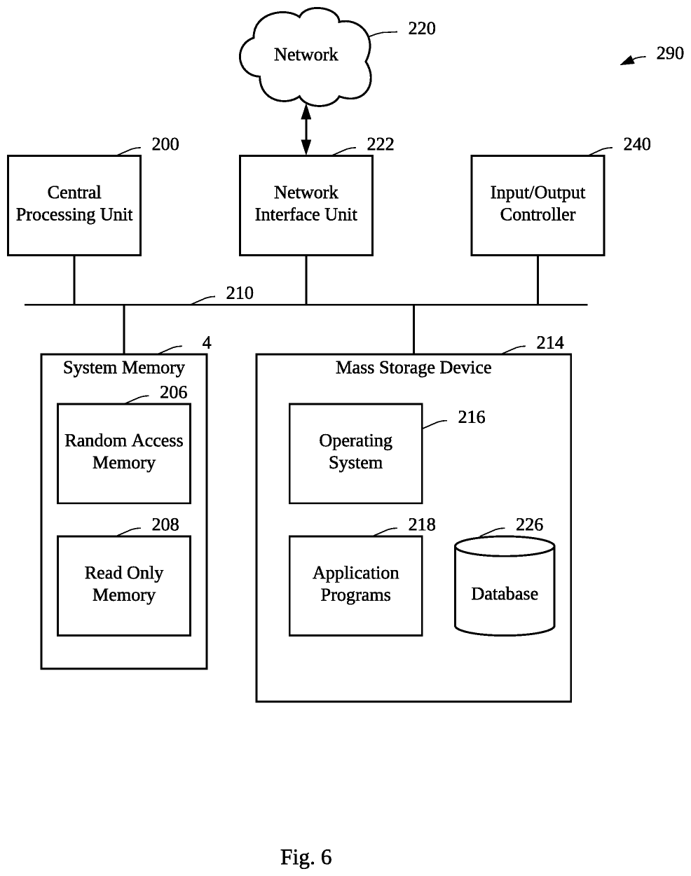

Referring now to FIG. 6, an illustrative computer architecture for a computer 290 utilized in the various embodiments will be described. The computer architecture shown in FIG. 5 may be configured as a server, desktop, or mobile computer and includes a central processing unit 200 (“CPU”), a system memory 204, including a random access memory 206 (“RAM”) and a read-only memory (“ROM”) 208, and a system bus 210 that couples the memory to the CPU 200.

A basic input/output system containing the basic routines that help to transfer information between elements within the computer, such as during startup, is stored in the ROM 208. The computer 290 further includes a mass storage device 214 for storing an operating system 216, application programs 218, and other program modules, which will be described in greater detail below.

The mass storage device 214 is connected to the CPU 200 through a mass storage controller (not shown) connected to the bus 210. The mass storage device 214 and its associated computer-readable media provide non-volatile storage for the computer 290. Although the description of computer-readable media contained herein refers to a mass storage device, such as a hard disk or CD-ROM drive, the computer-readable media can be any available media that can be accessed by the computer 290. The mass storage device 214 can also contain one or more databases 226.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 290.

According to various embodiments, computer 290 may operate in a networked environment using logical connections to remote computers through a network 220, such as the Internet. The computer 290 may connect to the network 220 through a network interface unit 222 connected to the bus 210. The network connection may be wireless and/or wired. The network interface unit 222 may also be utilized to connect to other types of networks and remote computer systems. The computer 290 may also include an input/output controller 224 for receiving and processing input from a number of other devices, including a keyboard, mouse, or electronic stylus (not shown in FIG. 6). Similarly, an input/output controller 224 may provide output to a display screen, a printer, or other type of output device (not shown).

As mentioned briefly above, a number of program modules and data files may be stored in the mass storage device 214 and RAM 206 of the computer 290, including an operating system 216 suitable for controlling the operation of a networked personal computer. The mass storage device 214 and RAM 206 may also store one or more program modules. In particular, the mass storage device 214 and the RAM 206 may store one or more application programs 218.

The foregoing disclosure hereby enables a person of ordinary skill in the art to make and use the disclosed systems without undue experimentation. Certain examples are given to for purposes of explanation and are not given in a limiting manner.

1. A system for dynamically allocating credit to a credit holder, the system comprising:
a monitoring module configured to monitor transactions executed by the credit holder using a payment instrument, including parameters pertaining to the transactions, the monitoring module being configured to perform calculations; and
a database configured to store the parameters including past values of the parameters;
wherein the monitoring module is configured to:
communicate with a bank, wherein the bank has issued the instrument to the credit holder;
in response to a function call to the monitoring module, identify a first set of the parameters and to compare the first set of parameters to one or more second sets of the parameters;
identify a similar set of parameters from among the second sets of the parameters, wherein the similar set of parameters is more similar to the current set of parameters than other past parameters;
establish a degree of similarity between the similar set of parameters and the first set of parameters;
identify a credit status for the credit holder at the time of the similar set of parameters;
assess the insufficiency of the credit status; and
dynamically allocate credit to the credit holder in concert with the bank according to the insufficiency of the credit status and the degree of similarity.

2. The system of claim 1 wherein the triggering event is at least one of time, a manual request for a dynamic credit reallocation, or a transaction.

3. The system of claim 1 wherein the parameters comprise one or more of amount of the transaction, time of the transaction, merchant in the transaction, place of the transaction, type of goods and/or services purchased, credit of the credit holder, debt of the credit holder, frequency of transaction, remaining balance in account of credit holder after transaction, and payroll information for the credit holder.

4. The system of claim 1 wherein the monitoring module is configured to receive a predetermined threshold for similarity between sets of parameters, wherein if set of parameters are dissimilar by an amount greater than the threshold, no credit adjustment is executed.

5. The system of claim 1 wherein the database is configured to store information pertaining to a plurality of accounts held by the credit holder.

6. The system of claim 1 wherein the sets of parameters comprise two or more parameters having incongruous units, and wherein the monitoring module is configured to normalize the units.

7. The system of claim 1 wherein the sets of parameters comprise two or more parameters that have inverse relationships with one another, and wherein the monitoring module is configured to normalize the parameters.

8. The system of claim 1 wherein the function call is initiated by at least one of a manual request, a time period expiration, and a transaction.

9. The system of claim 8 wherein the transaction comprises a transaction having an amount greater than a predetermined threshold.

10. The system of claim 8 wherein the time period expiration comprises a single day.

11. A method for dynamically allocating credit to a customer, the method comprising:
storing transaction data for the customer;
receiving a request to analyze a current credit for the customer to determine how to dynamically allocate credit to the customer;
identifying a present set of data from among the transaction data pertaining to the customer at a time the request was received;
comparing the present set of data to one or more past sets of data from among the transaction data for the customer;
identifying from among the past sets of data a second set of data that is most similar to the present set of data and establishing a degree of similarity between the second set of data and the present set of data;
analyzing for adequacy a second credit available to the customer at a time of the second set of data;
comparing a present credit available to the customer to the second credit; and
allocating credit to the customer according to the adequacy of the second credit and the degree of similarity between the second set of data and the present set of data.

12. The method of claim 11 wherein receiving a request to analyze comprises at least one of a manual request, a transaction, and a predetermined time expiration.

13. The method of claim 11 wherein comparing the present set of data to one or more past sets of data from the transaction data comprises comparing the present set of data to one or more past sets of data from the transaction data from one or more other users.

14. The method of claim F wherein the transaction data from the one or more other users is normalized.

15. The method of claim 11 wherein the transaction data comprises one or more of amount of the transaction, time of the transaction, merchant in the transaction, place of the transaction, type of goods and/or services purchased, credit of the credit holder, debt of the credit holder, frequency of transaction, remaining balance in account of credit holder after transaction, and payroll information.

16. The method of claim 11, further comprising receiving a similarity threshold by which to identify from among the past sets of data the second set of data as being the most similar to the present set of data.

17. The method of claim 11, further comprising storing industry information pertaining to the customer, and wherein the sets of data include the industry information.

18. The method of claim 11 wherein the sets of parameters comprise a string of variables, and wherein identifying from the pasts sets of data a second set of data comprises comparing strings of data on a variable-by-variable basis.

19. The method of claim 18, further comprising weighting the variables.

20. The method of claim 11, further comprising mathematically normalizing and combining the sets of data into a single number.

21. A method for dynamically allocating credit to a consumer on a transaction-by-transaction basis, the method comprising:
operating a computational model configured to communicate with a bank that issues a financial instrument for the consumer and to monitor for transactions executed by the consumer using the financial instrument and to store data for the transactions;
aggregating the data into parameter sets for each transaction;
at the time of a proposed transaction, aggregating data for the proposed transaction into a first parameter set for the proposed transaction and analyzing whether or not the proposed transaction would exceed a predetermined credit limit for the consumer;
if the proposed transaction would exceed the predetermined credit limit for the consumer, before denying the proposed transaction, analyzing the data to determine a second parameter set that is similar to the first parameter set;
analyzing whether or not the proposed transaction would have exceeded the credit of the consumer at the time of the second parameter set; and
if the proposed transaction would not have exceeded the credit of the consumer at the time of the second parameter set, approving the transaction.

22. The method of claim 21, further comprising calculating an insufficiency of the credit of the consumer at the time of the second parameter set and a similarity between the second parameter set and the first parameter set.

23. The method of claim 21, further comprising allocating credit to the consumer according to a product of the insufficiency and the similarity.
